(19) United States
(12) Patent Application Publication
(10) Pub. No.: US 2025/0216832 A1
(43) Pub. Date: Jul. 3, 2025

(54) SYSTEM AND METHOD FOR AUTOMATIC DATA EXTRACTION AND LABELLING FOR SUPERVISED MACHINE LEARNING TO AUTOMATE CNC MANUFACTURING

(71) Applicant: Hurco Companies, Inc., Indianapolis, IN (US)

(72) Inventors: Paul Gray, Zionsville, IN (US); Ian Roberts, Indianapolis, IN (US); Michael Lenover, Indianapolis, IN (US)

(21) Appl. No.: 18/397,368

(22) Filed: Dec. 27, 2023

(51) Int. Cl. G05B 19/4097

(52) U.S. Cl. CPC G05B 19/4097; G05B 2219/32153; G05B 2219/36039

(57) ABSTRACT

A method and system for automating CNC manufacturing is provided, comprising: receiving, at a server over a network, metadata from a plurality of CNC machines, the metadata from each CNC machine being automatically generated by a CNC control of the CNC machine as a result of an operator loading a CAD file of a first part to be formed by the CNC machine into CAM software of the CNC control and using the CAM software to define manufacturing process parameters and tool path parameters for forming the first part; training, by the server, a supervised machine learning model using the metadata as labeled training data to produce a trained model; and transmitting, by the server to at least one CNC machine of the plurality of CNC machines, model generated manufacturing process parameters and tool path parameters generated by the trained model for forming a second part.

### FIELD OF THE DISCLOSURE

The present disclosure relates to CNC manufacturing, and more particularly to automated CNC manufacturing enabled by automatic data extraction and labelling for supervised machine learning.

### BACKGROUND

Forming parts using machine tools such as Computer Numerical Control (“CNC”) machines (e.g., 3-axis CNC machines, 5-axis CNC machines, multi-axis, mill-turn machines, 2-axis lathes, etc.) is a highly precise, efficient way to create components for various products and equipment, especially when a large volume of identical parts are needed. The process of taking a part designed using Computer-Aided Design (“CAD”) software and generating instructions for forming the part using a CNC machine, however, requires the knowledge and skill of highly trained, very experienced operators. While in certain cases aspects of this process are automated or semi-automated, much of the work involved in defining the parameters, order of operation and hardware necessary to carry out the manufacturing process is directly performed by these highly skilled operators.

To provide context, FIG. 1 depicts an example of a CNC machine 10. CNC machine 10 includes a control console or CNC control 12 with user controls 14 and at least one viewable screen 16. The controls 14 and the viewable screen 16 allow an operator to generate part programs using conventional methods including accessing CAD and computer-aided manufacturing (“CAM”) programs. The CNC machine 10 includes a workspace 18, typically with a flat working surface 20, onto which an operator can secure or mount a blank or unformed workpiece. A plurality of working parts 22 are disposed in the workspace 18 are programmed to move according to the part program to form specific features on the workpiece.

As shown in FIG. 2, the workspace 18 of the CNC machine 10 includes a spindle head 24 having a motor housing 26, a head casting 28, a spindle 30 and coupling keys 32 which engage cutting tools. The working surface 20, in certain examples, includes grooves 36 and an optional working table 38. Grooves facilitate affixing material to be machined, or affixing a fixture, such as the working table 38 to the working surface 20. Working table 38 may have a flat upper surface 40 and groove-fitting lower surface 42. The upper surface 40 allows for a blank or unformed workpiece to be mounted to the working table 38. When the working surface moves in the X and Y directions, working table 38, or other affixed units, move with the working surface 20. The flat upper surface 40 may rotate about a rotary X axis, and the spindle head may rotate about a rotary B axis. Working parts 22 further include a ball screw 44 which facilitates movement of the spindle head 24 along the Z axis during a manufacturing process. The described movement of parts relative to the X, Y, Z, B and C axes, in one embodiment, is controlled to achieve tool paths required for forming a part having a geometry specified according to operation input in a part program.

A typical process flow 50 for CNC manufacturing is depicted in FIG. 3. At step 52, the part or finished workpiece is designed using CAD software such as, but not limited to, AutoCAD, SolidWorks, CATIA, Revit, or SketchUp. The CAD software enables designers and engineers to create, modify and analyze digital models of objects. Typically, the output of the CAD software (“the CAD file”) is a three-dimensional solid model of the part that defines all the geometric features and dimensions of the part, as well as the interrelations between the features. An example three-dimensional solid model 53 is depicted in FIG. 4. At step 54, the CAD file is loaded into CAM software residing on a CNC control 12 of the CNC machine 10. At step 56, the operator interacts with the CAM software to establish the manufacturing processes to form the part, a simulation of which is depicted in FIG. 5. At this stage of the process, the operator needs to identify the CNC machine 10 to be used, define the stock material (e.g., steel, aluminum, etc.) used to make the part, define the CNC machine setup, and identify the features of the part. The combination of these elements of the manufacturing process may be referred to herein as “the manufacturing process parameters.” The operator's skill and experience is required for each of the several decisions made in establishing the manufacturing process parameters. The operator typically understands through experience which CNC machine 10 should be used to form the part, considering the stock material, the size of the stock material (i.e., the unformed workpiece), and the general manner in which the features will be cut, among other things. Knowing the CNC machine 10 to be used to cut the part, the operator defines the process plan 55 or order of operations for cutting the part (an example is depicted in FIG. 6), as well as how the part will be secured or fixtured in the workspace 18 of the CNC machine 10 and how many setups will be required to cut the part. The number of setups (e.g., repositioning of the workpiece, moving clamps, etc.) depends on the type of CNC machine 10 being used, among other things. For example, if a 5-axis CNC machine such as that described above is used to form features on multiple sides of the workpiece, then the process 50 may require only one or two setups. If, on the other hand, a 3-axis CNC machine is used, the operator may need to define five or six setups to form all the features on the different sides of the workpiece.

At step 58, the operator must generate a program for the tool paths to be used to cut the features, which includes specifying the type and size of cutting tool (e.g., an end mill, a face mill, a ball cutter, a slab milling tool, a side milling cutter, a staggered milling cutter, a concave or convex cutter, etc.). The tool paths must also define the manner in which the cutting tool is moved from one position to another in the workspace 18 of the CNC machine 10 (i.e., linking moves) to avoid making unwanted contact with the workpiece or the CNC machine 10. In a typical milling process, the process plan starts with facing the stock material or workpiece to create square intersections between surfaces and form the overall finished part dimensions. After that, the features that obstruct other features have cutting priority (i.e., these features are cut before the obstructed features). Typically, the features are first rough-machined (i.e., cut to near the final dimensions), then semi-machined and finish-machined, where each machining operation removes less material than the previous machining operation to minimize the cutting forces required and wear on the cutting tools, and to achieve the best dimensional tolerance and surface finish.

Each setup defined by the operator will include one or more features and the operator must define the best tool path parameters to cut the features. Features may include pockets, islands, holes, faces, threaded holes, surfaces, slots, grooves, etc. In addition to specifying the tools required to form each feature, the operator must specify the cutting parameters associated with the tool paths, including step-over (i.e., the overlap between adjacent passes of the cutting tool), peck depth (i.e., the depth of sequential drilling and retraction operations that facilitate chip breaking and clearing), plunge type (e.g., straight plunging, helical plunging, linear ramping, etc.), feed rate (i.e., the distance the cutting tool travels during a revolution of the spindle and the velocity at which the tool is advanced while cutting the workpiece), cutting speed (i.e., the relative velocity between the surface of the workpiece and the cutting tool), etc. The above-described elements of generating the tool path (i.e., defining the path to be followed to cut the features, the type and size of the cutting tool, the manner in which it is moved from one position to another, and the cutting parameters) are collectively referred to herein as “the tool path parameters.” In conventional CNC machining, each of these parameter specifications requires operator understanding of the limits of the CNC machine 10, the safe operation of the cutting tools being used, and the specified capabilities of the CNC machine 10 for various tool-material combinations.

At step 60, after all the operations are specified in the correct sequence, the operator posts the process to the CNC machine 10. In other words, the programmed commands are translated into code that is executable by the CNC machine 10. Typically, the programmed process is converted into a machine-readable language called G-code to generate a part program. The part program is a text file containing all the G-code to specify the tool path end points for the cutting tools to traverse in a point-to-point sequence to cut the part. The part program also includes non-cutting commands such as commands for cutting tool changes, work offsets, and auxiliary functions like coolant pump operations, among others. In general, the part program is completely disassociated with the CAD file used to generate the part program. The part program only includes the centerline 3D trajectories of the cutting tools and retains no native geometric information of the CAD file describing the part. Thus, in conventional CNC manufacturing, the CNC control 12 is not knowledgeable of the characteristics of the finished part. It is up to the operator to define the cutting tools and their respective geometries in the CNC control 12, to mount the fixturing devices for the workpiece, and to measure their relative locations within the workspace 18 of the CNC machine 10 to set the work offsets of the part program. The operator must also measure the cutting tools prior to cutting the workpiece to account for dimensional changes resulting from wear.

At step 62, the operator sets up the part and the tools needed to form the part. More specifically, the operator secures the stock material for the part in a securing device (e.g., a vice, a clamp, etc.) within the workspace 18 of the CNC machine 10 and installs the required cutting tool in the spindle 30 of the CNC machine 10 and/or a tool holder associated with the CNC machine 10.

After the setup, at step 64 the operator initiates the cutting process and the CNC machine 10 forms the part according to the part program. As indicated by step 66, at various stages of cutting the part, the operator may make adjustments to the cutting process. For example, the operator may use manual overrides on the CNC control 12 to adjust the feeds and speeds to optimize the cutting performance, reduce vibration, and improve surface finish. In some instances, the operator interrupts operation of the part program to measure critical features to ensure they are within the specified tolerances, and to adjust tool wear definitions and geometry offsets to accommodate for cutting tool wear and deflection. These actions are collectively referred to herein as “in-process adjustments.”

As should be apparent from the foregoing, while various aspects of the typical CNC manufacturing process flow 50 are carried out automatically, the definition of the process flow is intensely dependent upon the input of highly skilled, experienced operators. From determining what is a feature, to what machining operation should be used to cut the feature and in what sequence, to what tool path should be used, what tools should be used, and what cutting parameters are needed to machine the entire part, the conventional process flow requires a substantial number of human-specified commands, which requires expert operators with significant industry-specific training and experience. As relatively few such expert operators exist, it difficult and costly for manufacturing companies to attract and retain them. Moreover, the loss of such an expert operator through retirement, departure to a new employer or otherwise, can cause a great disruption to the operations of a manufacturing company, especially small to mid-size companies. Accordingly, it is desirable to reduce the level of reliance on human experts for carrying out CNC manufacturing processes, to improve efficiency, reduce cost and waste, and improve accuracy.

### SUMMARY

According to one embodiment, the present disclosure provides a method for automating CNC manufacturing, comprising: receiving, at one or more servers over a network, metadata from a plurality of CNC machines, the metadata from each CNC machine being automatically generated by a CNC control of the CNC machine as a result of an operator loading a CAD file of a first part to be formed by the CNC machine into CAM software of the CNC control and using the CAM software to define manufacturing process parameters and tool path parameters for forming the first part; training, by the one or more servers, a supervised machine learning model using the metadata as labeled training data to produce a trained model; and transmitting, by the one or more servers to at least one CNC machine of the plurality of CNC machines, model generated manufacturing process parameters and tool path parameters generated by the trained model for forming a second part. In one aspect of this embodiment, transmitting is in response to an operator loading a CAD file of the second part into CAM software of a CNC control of the at least one CNC machine. In another aspect, the model generated manufacturing process parameters include an identification of a CNC machine, a definition of stock material to form the second part, a setup of the CNC machine, and an identification of at least one feature of the second part. In another aspect, the model generated tool path parameters include a definition of at least one tool path to form the at least one feature, a definition of linking moves for a cutting tool of the CNC machine, a specification of a type and size of the cutting tool, and a specification of cutting tool parameters. In a variant of this aspect, the cutting tool parameters include parameters defining at least one of step-over, peck depth, plunge type, feed rate or cutting speed of the cutting tool. In another aspect, receiving metadata includes receiving part manufacturing programs containing the metadata from the plurality of CNC machines. In a variant of this aspect, each of the part manufacturing programs is generated by a packaging module of a CNC control of one of CNC machines of the plurality of CNC machines. In yet another aspect, the metadata includes a plurality of metadata types from a group of metadata types including part metadata, feature metadata, process plan metadata, machining metadata, part setup metadata, production metadata, and in-process metadata. In a variant of this aspect, part metadata includes at least one of an industry classification of the first part, a CNC machine for forming the first part, a quantity of first parts to produce, and an identification of the CAD file. In a further variant, the feature metadata includes at least one of a feature label, a feature geometry, a feature topology, a feature tolerance, and a definition of an interaction of a feature relative to another feature. In a further variant, the process plan metadata includes at least one of a machining operation, a feature program sequence, a definition of feature dependence, feature relational data, a tool change sequence, a rotary axes index sequence, a part setup sequence and a fixturing sequence. In a further variant, the machining metadata includes at least one of data associated with operation types, operation sequences, operation tools, and operation parameters. In yet a further variant, the part setup metadata includes at least one of a part location in a workspace of a CNC machine, a fixture type, and a number of setups. In another variant, the production metadata includes at least one of a cost of producing the first part, data associated with a robotic process, and characteristics of a CNC machine. In a further variant, transmitting further comprises transmitting, by the one or more servers to the at least one CNC machine of the plurality of CNC machines, a model generated cost estimate of forming the second part. In another variant, the in-process metadata includes at least one of a tool wear adjustment, a speed adjustment, a feed adjustment, a motor performance parameter, and a gauging inspection result. In another aspect of this embodiment, the supervised machine learning model is one of a plurality of supervised machine learning models on the one or more server. In another aspect, the first CAD file is a 3D solid model CAD file. In yet another aspect, the model generated manufacturing process parameters and tool path parameters are configured to permit an operator to accept, reject or modify one or more of the parameters. A variant of this aspect further comprises receiving, at the one or more servers over the network, updated metadata representing at least one of an operator rejection or modification to the one or more parameters, and training further comprises training the supervised machine learning model using the updated metadata as labeled training data. Yet another aspect further comprises receiving at least one of a classification of the second part or an identification of an end user of the at least one of the plurality of CNC machines. Another aspect further comprises: generating a simulated part, by the one or more servers, using the model generated manufacturing process parameters and tool path parameters; comparing, by the one or more servers, at least one feature of the simulated part to a corresponding feature in a CAD file of a part corresponding to the simulated part; computing, by the one or more servers, a difference between the at least one feature and the corresponding feature; using, by the one or more servers, the difference to generate new training data; and training, by the one or more servers, the supervised machine learning model using the new training data. Another aspect further comprises validating, by the one or more servers, at least one parameter of the model generated manufacturing process parameters and tool path parameters by simulating cutting mechanics and/or vibrations associated with the at least one parameter. A variant of this aspect further comprises: identifying, by the one or more servers, at least one error associated with the at least one parameter based upon at least one of allowable forces, tool deflection, surface roughness and vibrations; and training, by the one or more servers, the supervised machine learning model using the at least one error as labeled training data. In still another aspect, the metadata includes randomized modifications of geometric and topological data of the first part to prevent reverse-engineering of the first part. In a variant of this aspect, the randomized modifications include one or more of scaling, position, orientation, skew, and subdivision of the first part into multiple parts.

In another embodiment, the present disclosure provides a method for automating CNC manufacturing, comprising: capturing, by a CNC control of a CNC machine, metadata generated by loading a first CAD file of a first part into CAM software of the CNC control and using the CAM software to define manufacturing process parameters and tool path parameters for forming the first part using the CNC machine; packaging, by a packaging module of the CNC control, the metadata into a part manufacturing program; transmitting, by the CNC control, the part manufacturing program over a network to one or more servers which use the metadata in the part manufacturing program as labeled training data to train a supervised machine learning model to produce a trained model; receiving, by the CAM software of the CNC control, a second CAD file of a second part; and in response to receiving the second CAD file, receiving, at the CNC control, model generated manufacturing process parameters and tool path parameters generated by the trained model for forming the second part. In one aspect of this embodiment, the model generated manufacturing process parameters include an identification of a CNC machine, a definition of stock material to form the second part, a setup of the CNC machine, and an identification of at least one feature of the second part. In another aspect, the model generated tool path parameters include a definition of at least one tool path to form the at least one feature, a definition of linking moves for a cutting tool of the CNC machine, a specification of a type and size of the cutting tool, and a specification of cutting tool parameters. In a variant of this aspect, the cutting tool parameters include parameters defining at least one of step-over, peck depth, plunge type, feed rate or cutting speed of the cutting tool. In another aspect, the metadata includes a plurality of metadata types from a group of metadata types including part metadata, feature metadata, process plan metadata, machining metadata, part setup metadata, production metadata, and in-process metadata. Another aspect of this embodiment further comprises receiving, at the CNC control, cost estimate of forming the second part generated by the trained model. In another aspect, the supervised machine learning model is one of a plurality of supervised machine learning models on the one or more server. In another aspect, the first CAD file is a 3D solid model CAD file. In another aspect, the model generated manufacturing process parameters and tool path parameters are configured to permit an operator to accept, reject or modify one or more of the parameters. A variant of this aspect further comprises transmitting, by the CNC control over the network, updated metadata representing at least one of an operator rejection or modification to the one or more parameters for use by the one or more servers to further train the supervised machine learning model. Another aspect further comprises transmitting, by the CNC control, at least one of a classification of the second part or an identification of an end user of the CNC machine. Another aspect further comprises: generating a simulated part, by the CNC control, using the model generated manufacturing process parameters and tool path parameters; comparing, by CNC control, at least one feature of the simulated part to a corresponding feature in a CAD file of a part corresponding to the simulated part; computing, by CNC control, a difference between the at least one feature and the corresponding feature; using, by the CNC control, the different to generate new training data; and transmitting, by the CNC control to the one or more servers over the network, the new training data to train the supervised machine learning model. In another aspect, the metadata includes randomized modifications of geometric and topological data of the first part to prevent reverse-engineering of the first part. In a variant of this aspect, the randomized modifications include one or more of scaling, position, orientation, skew, and subdivision of the first part into multiple parts.

In yet another embodiment, the present disclosure provides a system for automating CNC manufacturing, comprising: a plurality of CNC machines, each including a CNC control; and one or more servers communicatively coupled to the plurality of CNC machines over a network, the one or more servers including a plurality of supervised machine learning models; wherein each CNC control includes a packaging module configured to package metadata into a part manufacturing program generated by loading a first CAD file of a first part into CAM software of the CNC control and using the CAM software to define manufacturing process parameters and tool path parameters for forming the first part using the corresponding CNC machine; wherein each CNC control is configured to transmit the part manufacturing program over the network to the one or more servers; wherein the one or more servers is configured to use the metadata in the part manufacturing program as labeled training data to train at least one of the plurality of supervised machine learning models to produce a trained model; and wherein the one or more servers is configured to respond to a second CAD file of a second part being loaded into the CAM software of one of the CNC controls by transmitting to the one CNC control model generated manufacturing process parameters and tool path parameters generated by the trained model for forming the second part. In one aspect of this embodiment, the model generated manufacturing process parameters include an identification of a CNC machine, a definition of stock material to form the second part, a setup of the CNC machine, and an identification of at least one feature of the second part. In another aspect, the model generated tool path parameters include a definition of at least one tool path to form the at least one feature, a definition of linking moves for a cutting tool of the CNC machine, a specification of a type and size of the cutting tool, and a specification of cutting tool parameters. In a variant of this aspect, the cutting tool parameters include parameters defining at least one of step-over, peck depth, plunge type, feed rate or cutting speed of the cutting tool. In yet another aspect, the metadata includes a plurality of metadata types from a group of metadata types including part metadata, feature metadata, process plan metadata, machining metadata, part setup metadata, production metadata, and in-process metadata. In another aspect, the first CAD file is a 3D solid model CAD file. In another aspect, the model generated manufacturing process parameters and tool path parameters are configured to permit an operator to accept, reject or modify one or more of the parameters. In a variant of this aspect, the one or more servers is further configured to receive over the network, updated metadata representing at least one of an operator rejection or modification to the one or more parameters, and train the at least one of the plurality of supervised machine learning models using the updated data. In another aspect, at least one of the CNC controls of at least one of the CNC machines is configured to transmit to the one or more servers at least one of a classification of the second part or an identification of an end user of the at least one CNC machine. In another aspect of this embodiment, each of the CNC controls or one of the one or more servers is further configured to: generate a simulated part using the model generated manufacturing process parameters and tool path parameters; compare at least one feature of the simulated part to a corresponding feature in a CAD file of a part corresponding to the simulated part; compute a difference between the at least one feature and the corresponding feature; use the difference to generate new training data; and train the at least one of the plurality of supervised machine learning models using the new training data. In another aspect, the one or more servers is further configured to validate at least one parameter of the model generated manufacturing process parameters and tool path parameters by simulating cutting mechanics and/or vibrations associated with the at least one parameter. In yet another aspect, the one or more servers is further configured to: identify at least one error associated with the at least one parameter based upon at least one of allowable forces, tool deflection, surface roughness and vibrations; and train the at least one of a plurality of supervised machine learning models using the at least one error as labeled training data. In another aspect, at least one of the CNC controls is configured to make randomized modifications of geometric and topological data of the first part in the metadata to prevent reverse-engineering of the first part. In a variant of this aspect, the randomized modifications include one or more of scaling, position, orientation, skew, and subdivision of the first part into multiple parts.

In yet another embodiment, the present disclosure provides a system for automating CNC manufacturing, comprising: a CNC machine including a CNC control; and one or more remote computing devices communicatively coupled to the CNC control over a network, the CNC control and/or the one or more remote computing devices including a plurality of supervised machine learning models; wherein the CNC control is configured to extract metadata generated by loading a first CAD file of a first part into CAM software of the CNC control and using the CAM software to define manufacturing process parameters and tool path parameters for forming the first part using the CNC machine, the metadata being packaged as a part manufacturing program; wherein the CNC control is configured to transmit the part manufacturing program over the network to the one or more remote computing devices; wherein the CNC control and/or the one or more remote computing devices is configured to use the metadata in the part manufacturing program as labeled training data to train at least one of the plurality of supervised machine learning models to produce a trained model; and wherein the CNC control and/or the one or more remote computing devices is configured to respond to a second CAD file of a second part being loaded into the CAM software of the CNC control by accessing model generated manufacturing process parameters and tool path parameters generated by the trained model for forming the second part.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

The above-mentioned and other features of this disclosure and the manner of obtaining them will become more apparent and the disclosure itself will be better understood by reference to the following description of embodiments of the present disclosure taken in conjunction with the accompanying drawings, wherein:

FIG. 1 is a perspective view of a CNC machine;

FIG. 2 is a perspective view of a workspace of the CNC machine of FIG. 1;

FIG. 3 is a block diagram of a CNC manufacturing process;

FIG. 4 is a screenshot of a simulation of a part to be formed by a CNC machine;

FIG. 5 is a screenshot of a simulation of a manufacturing process;

FIG. 6 is a screenshot of process plan for cutting a part;

FIG. 7 is a conceptual diagram of metadata categories generated through use of a CNC machine;

FIG. 8 is a conceptual diagram depicting the incorporation of the metadata of FIG. 7 into a part manufacturing program for transmission to a server;

FIG. 9 is a conceptual diagram depicting the packaging of the metadata of FIG. 7 and transmission of the part manufacturing program to the server of FIG. 8;

FIG. 10 is a conceptual diagram of a plurality of CNC machines in communication with the server of FIG. 8;

FIG. 11 is a conceptual diagram of the execution of a model developed according to the present disclosure by a control of a CNC machine;

FIG. 12 is a conceptual diagram depicting continuous updating of the model of FIG. 11 by connected CNC machines and the delivery of the updated model to other CNC machines;

FIG. 13 is a flow chart depicting automatic updating of machine learning models using simulations;

FIG. 14A is a perspective view of a part; and

FIG. 14B is a perspective view of the part of FIG. 14A after morphing data to prevent reverse engineering.

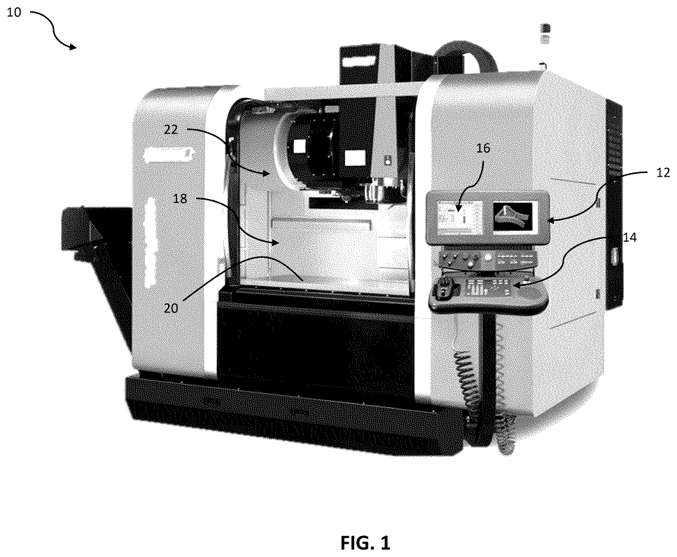

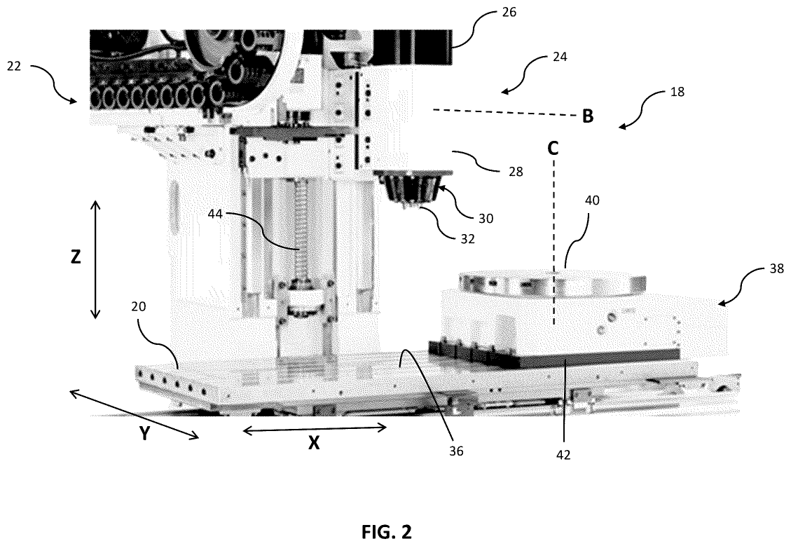

While the present disclosure is amenable to various modifications and alternative forms, specific embodiments have been shown by way of example in the drawings and are described in detail below. The present disclosure, however, is not to limit the particular embodiments described. On the contrary, the present disclosure is intended to cover all modifications, equivalents, and alternatives falling within the scope of the appended claims.

### DETAILED DESCRIPTION OF EMBODIMENTS OF THE DISCLOSURE

It should be understood that while this disclosure primarily uses CNC milling machines and/or CNC lathes as examples, the principles of the present disclosure have applicability to other CNC machines such as, but not limited to, CNC routers, CNC plasma cutters, CNC electric discharge machines, and CNC laser cutters, or even additive manufacturing machines such as 3D printers.

As described below, the present disclosure provides systems and methods for improving the autonomy of the CNC manufacturing process (i.e., reducing the reliance on expert operators) using machine learning to generate models to automate and optimize the manufacturing process. As is well understood in the field of artificial intelligence (“AI”), large amounts of data are necessary for successful model training. For supervised machine learning, as proposed herein, the relevant training data (i.e., input to the model) is labeled, while in unsupervised machine learning the training data is not labeled. Unsupervised machine learning requires vast amounts of data for self-categorization and training. While supervised learning requires less data, it also requires access to or generation of quality, accurate, machine-readable labeled data, which is the cornerstone of classification machine models and predictive regression machine models. Labeled data sets are data where the input data is directly associated with the desired output. In the case of classification models, an example input to the model may be a picture of a car, and the desired output is the identification of the image as that of a car. Many images known to be cars (i.e., labeled data of cars) of different makes, from different angles, etc., may be provided to the model to train it to successfully identify cars in unlabeled input data. This is to be contrasted with regression models, which establish a relationship between a single dependent variable and multiple independent input variables. A regression model example could be sales forecasting, where the input data may include regional market data, company divisional sales data, quantity of qualified leads generated, marketing spend, etc.

In any event, for supervised machine learning to be successful, large quantities of accurately labeled data is required, and contrary to popular belief, especially in the field of performance monitoring with Industrial Internet-of-Things (“IIOT”), such quality CNC manufacturing data is not readily available. Moreover, it is difficult to generate such data in the context of automating the CNC manufacturing process. While certain subsets of data can be collected, the processes involved in CNC manufacturing are generally separate and distributed across different software programs and platforms. There simply are no repositories of labeled data covering the entire process for automated part feature recognition, automated process planning, automated manufacturing path generation and automated manufacturing process data generation. Since the various data sites are disconnected from the CNC control 12 and actual tooling and CNC measuring and fixture setup that are established by the operator, it would be difficult if not impossible to collect a sufficient quantity of data with the requisite accuracy as most of the manufacturing data and adjustments would consequently have to rely on self-reporting by the operators. For example, it is conceivable that an operator could use a device such as a tablet PC to enter self-reported data related to the operational efficiency of a manufacturing process such as time taken to setup tools and fixtures and time taken for cleaning and repairs. Such self-reported data, however, frequently includes considerable inaccuracies and bias, and is not sufficiently reliable to be used in the training of machine learning models.

As should be apparent from the foregoing, to improve the autonomy of the CNC manufacturing process, data transfer from these separate processes and software applications needs to be improved. While processing can be either distributed or centralized, to automate it with machine learning and possibly optimize beyond a singular process, there must be access to sufficient data that covers as much of the CNC manufacturing process as possible. As described below, the present disclosure provides systems and methods that permit automatic extraction of data from the normal daily use of CNC machines 10 without any extra self-reporting efforts required of the operators or any additional devices or sensors. Simply by using the CNC machine 10 and programming parts in a conventional manner, operators are self-labeling data that exists within the system which can be automatically extracted as metadata to be used to train supervised machine learning models.

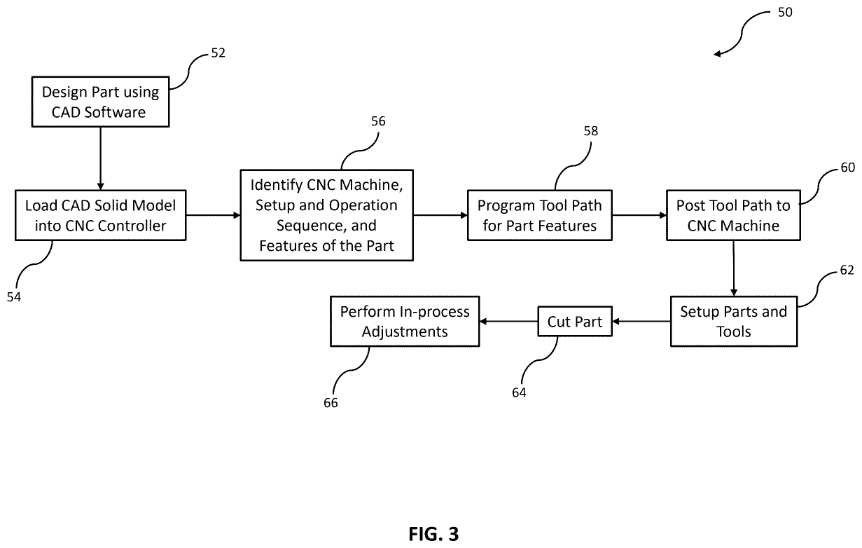

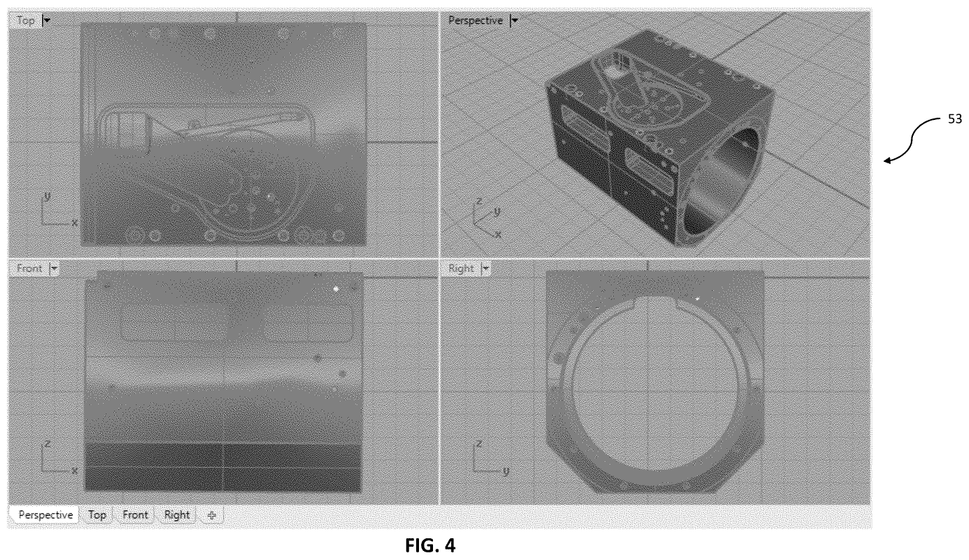

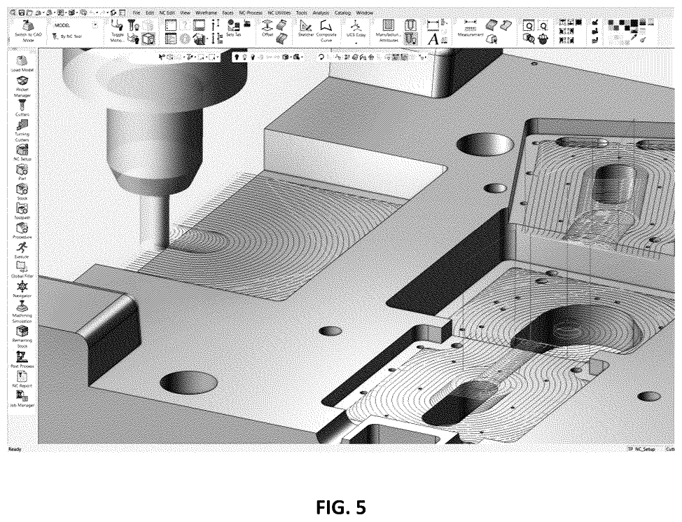

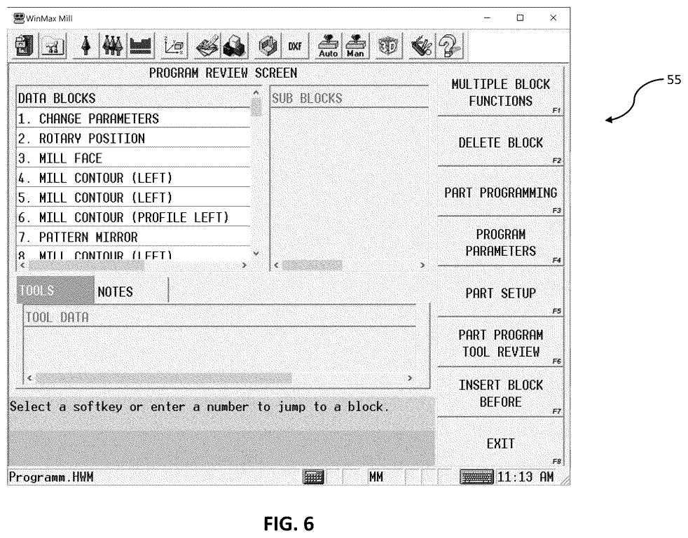

One aspect of this automatic data extraction involves the use of a solid model import feature on the CNC control 12, such as the solid model 3D import feature including 3D DXF technology made available for 3-axis and 5-axis machining centers by Hurco (hereinafter, “the Hurco 3D import feature”). While some CNC controls 12 have tool path generation capabilities, most are rudimentary and require the user to enter the geometric data manually by entering endpoints of arcs and lines, for example. Others will load only 2D line drawings that encapsulate only a limited definition of the part to be cut. Even the few CNC controls 12 capable of loading 3D solid model CAD files into the control 12, still have limited ability to generate tool paths. The Hurco 3D import feature, however, can import 3D solid model CAD files and generate tool paths for 3, 4 and 5-axis milling machines and multi-axis turning machines including for cutting 3D surfaces. The process and data flow in the Hurco 3D import feature essentially mirrors the process depicted in FIG. 3, but it is fully encapsulated within the Hurco CNC control.

More specifically, with the Hurco 3D import feature, solid models are loaded into the Hurco control 12, and by selecting features and generating data blocks in the Hurco control 12 to generate a conversational program and ordering the feature cutting in the sequence of operations to cut the part, the operators are inherently self-labeling data that may be extracted using the processes described herein. As is further described below, the metadata is collected throughout the entire workflow and may be packaged and transmitted through the cloud for use in supervised machine learning of various machine learning models to automate and optimize manufacturing processes including, but not limited to, identifying features in the solid model, selecting machining operations for the features, selecting the machining parameters and tools to cut the features, determining the order of operations to complete the part, providing closed-loop analysis and corrective incremental machine learning model improvement and updating, as well as job cost estimation.

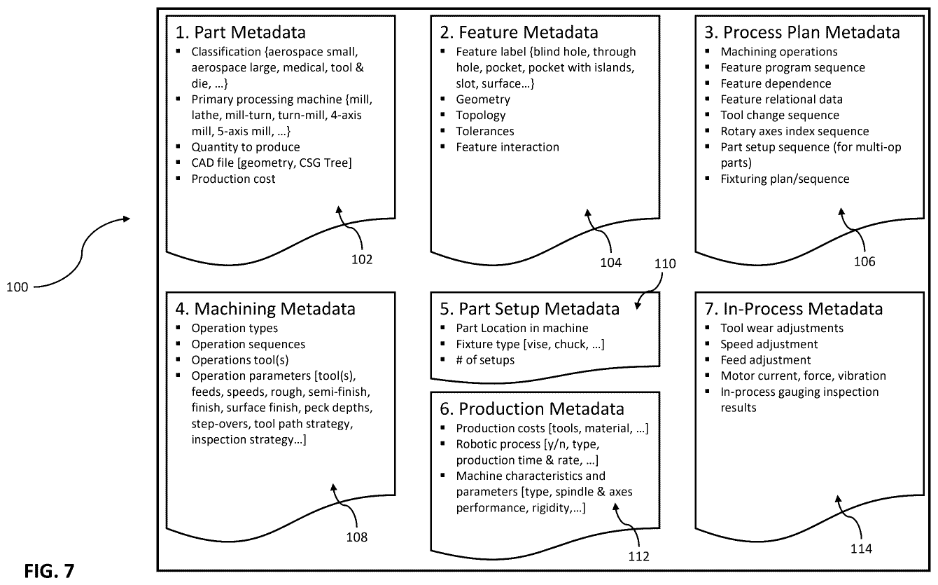

Referring now to FIG. 7, a conceptual diagram of the metadata 100 which is embedded in a part manufacturing program throughout the operational process of programming a typical CNC machine 10 and cutting a part is shown. As shown, the metadata 100 includes several classifications of metadata, including part metadata 102, feature metadata 104, process plan metadata 106, machining metadata 108, part setup metadata 110, production metadata 112 and in-process metadata 114. The part metadata 102 may include data describing the classification of the part by industry, for example, the primary CNC machine 10 to be used to create the part (e.g., mill, lathe, etc.), the quantity of parts to be produced, the CAD file for the part, and the costs associated with producing the part. The feature metadata 104 may include data describing the type of feature (e.g., pocket, slot, etc.), the geometry of the feature and its topology, the tolerances associated with the feature and the interactions or interrelationships of the feature with other features. The process plan metadata 106 may include data describing the machining operations to be executed, the feature program sequence, feature dependence, feature relational characteristics, tool change sequences, rotary axes index sequences, part setup sequences and fixturing sequences. The machining metadata 108 may include data describing the types and sequences of operations to be performed to form the part, as well as the operational tools to be used and the operation parameters such as feeds, speeds, etc. The part setup metadata 110 may include data describing the location of the part in the CNC machine, the type of fixture to be used and the number of setups needed to form the part. The production metadata 112 may include data describing the production costs associated with the tools and materials to be used, the robotic process and the machine characteristics and parameters such as type, spindle and axis performance, rigidity, etc. Finally, the in-process metadata 114 may include data describing any adjustments made during the actual machining process such as tool wear adjustments, feed and speed adjustments, motor current, force and/or vibration adjustments and in-process gauging inspection results.

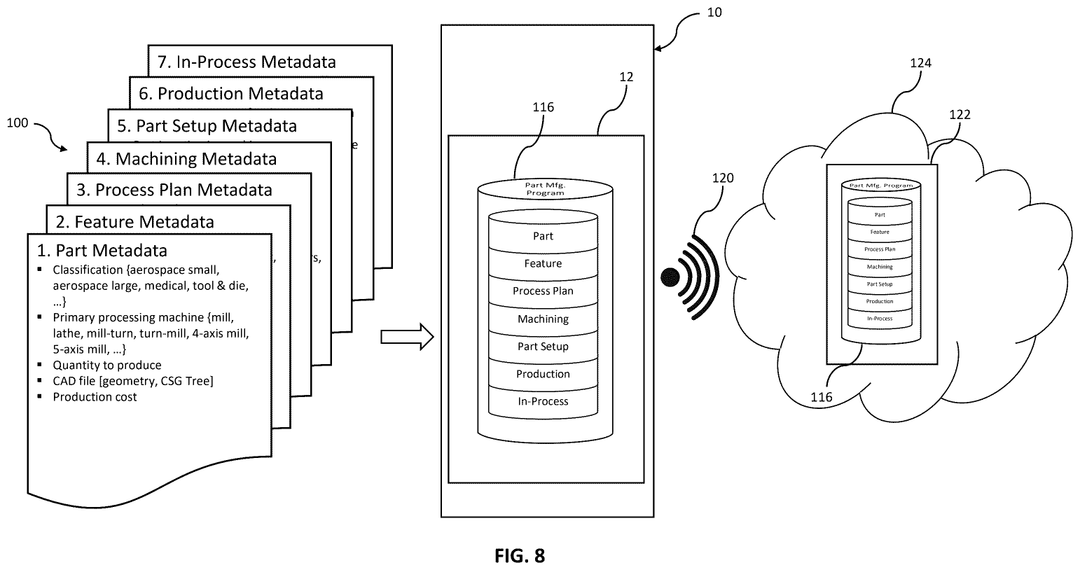

As shown in FIG. 8, the metadata 100 generated from the manufacturing process is packaged in a part manufacturing program 116 by the CNC control 12 of the CNC machine 10 and transmitted over a network 120 to one or more servers 122 in the cloud 124 where it is used in supervised machine learning of various machine learning models to automate and optimize manufacturing processes.

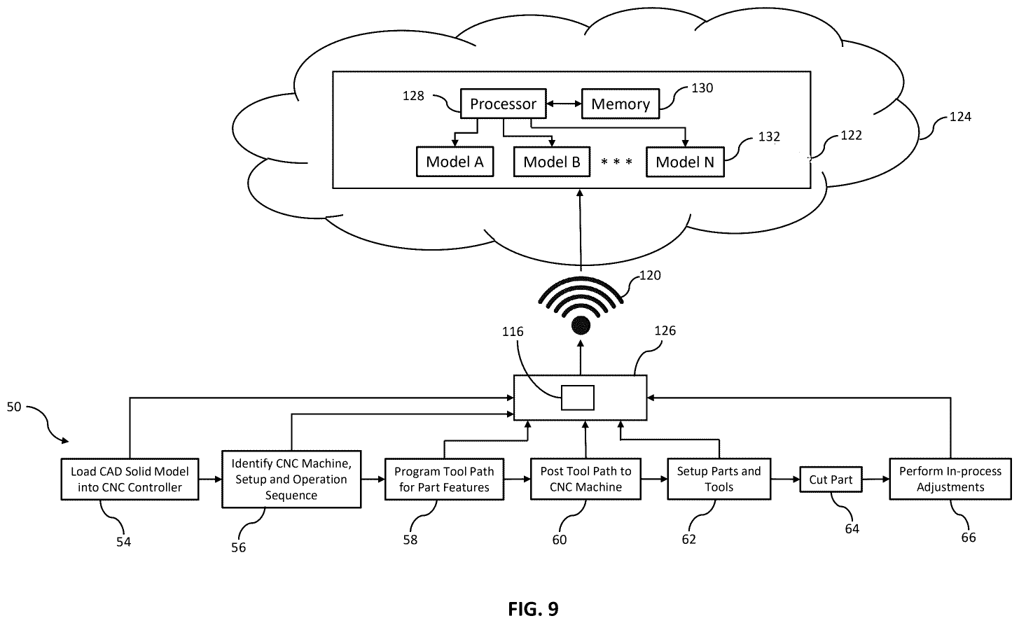

More specifically, and referring to FIG. 9, during a typical process flow 50 for CNC manufacturing as described above with reference to FIG. 3, a packaging module 126 of the CNC control 12 receives the metadata 100 during the various steps of the process flow 10 and generates the part manufacturing program 116 containing the metadata 100. The part manufacturing program 116 is transmitted over the network 120 to the one or more servers 122 (referred to hereinafter as “the server 122”) in the cloud 124. The server 122 includes one or more processors 128 and one or more memory devices 130. The one or more processors 128 provide the part manufacturing program 116 including the metadata 100 as an input to one or more supervised machine learning models 132 (hereinafter referred to as “the model 132”). As the CNC machine 10 is used in the normal course to manufacture parts, additional metadata 100 is automatically labeled and collected, packaged by the packaging module 126, and transmitted to the server 122 to provide additional labeled training data to the model 132.

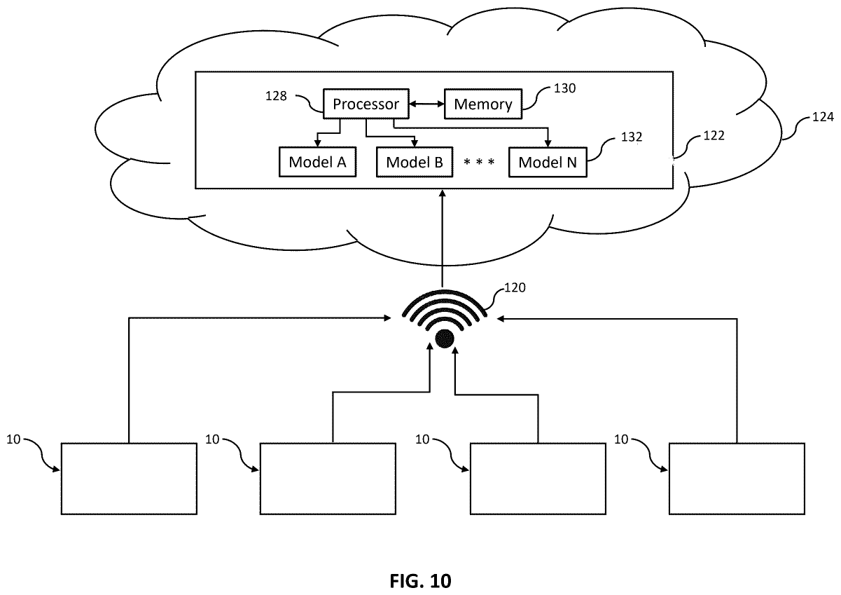

As shown in FIG. 10, a plurality of CNC machines 10 may be connected to the server 122 via the network 120. In this manner, a large quantity of metadata 100 in associated part manufacturing programs 116 may be collected and transmitted to the server 122 to train the model 132. By receiving metadata 100 from many different CNC machines 10, the server 122 can provide labeled training data to a variety of different supervised machine learning models 132 to improve the accuracy of the models 132 in automating and optimizing various manufacturing processes.

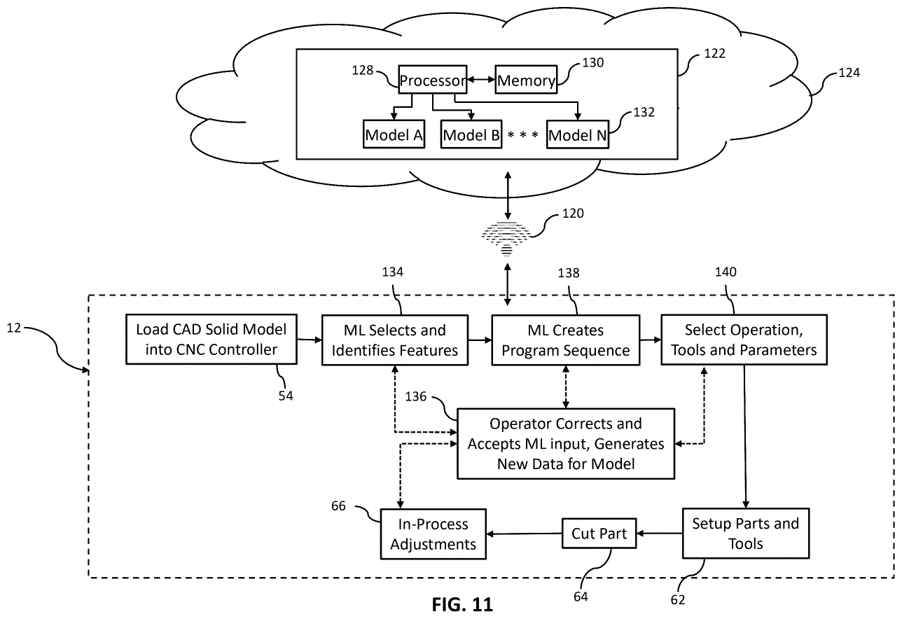

After the data collection and model training described above, a sufficiently trained model 132 may be generated and then deployed to CNC machines 10 to provide machine learning assisted process automation to the operator. During each step of the manufacturing process, the CNC control 12 presents the results of the machine learning model 132 to the operator. If any of the results are not what the operator expects or wants, they have the opportunity to correct it. As shown in FIG. 11, when a CAD model is loaded into the CNC control 12 at step 54, the control 12 communicates with the server 122 over the network 120 and the server 122 activates an appropriate trained model 132 to evaluate the CAD model and automatically provide machine learning assisted process automation to the operator. More specifically, at step 134 the workpiece features identified and selected by the model 132 are communicated via the CNC control 12 to the operator. As indicated by block 136 of FIG. 11, the operator may accept the results of the model 132 or reject or correct one or more aspect of the result. For example, if a feature is determined to be a blind hole but the operator determines it is a circular pocket, the operator simply changes the data block type for the feature. If the operator rejects or corrects one or more aspects of the result, the fact of the rejection and/or the manner of the correction generates new data which is communicated via the network 120 to the server 122 to provide further refinement of the model 132. Similarly, at step 138 a program sequence generated by the model 132 based upon the results of step 134 (whether accepted, rejected, or corrected by the operator) is presented to the operator. Again, as indicated by block 136, the operator may accept, reject or correct one or more aspects of the program sequence generated by the model 132. Any aspects that are rejected or corrected represent new training data that is communicated to the server 122 via the network 120 to further train the model 132. At step 140, the operations, tools and parameters determined by the model 132 for creating the part are presented to the operator to be accepted, rejected or corrected as described above. Next, the operator sets up the parts and tools (step 62) and activates the CNC machine 10 to cut the part (step 64). During the cutting process, the operator may perform certain in-process adjustments and/or measurements at step 66 as described above with reference FIG. 3. To the extent these adjustments adjust or correct aspects of the cutting process, the data generated as a result of the adjustments is transmitted to the server 122 via the network 120 to be used as training data to refine the model 132.

As should be understood from the foregoing, by correcting the machine model 132, the operator generates new updated metadata 100, which is extracted and packaged by the packaging module 126 and uploaded to the server 122 for use in updating the training of the machine model 132 through incremental learning processing. This process ensures that the machine learning model 132 is continually improving in accuracy and robustness. As the model 132 improves, it can be deployed through the network 120 to all connected CNC machines 10, thereby increasing the autonomy of all the CNC machines 10.

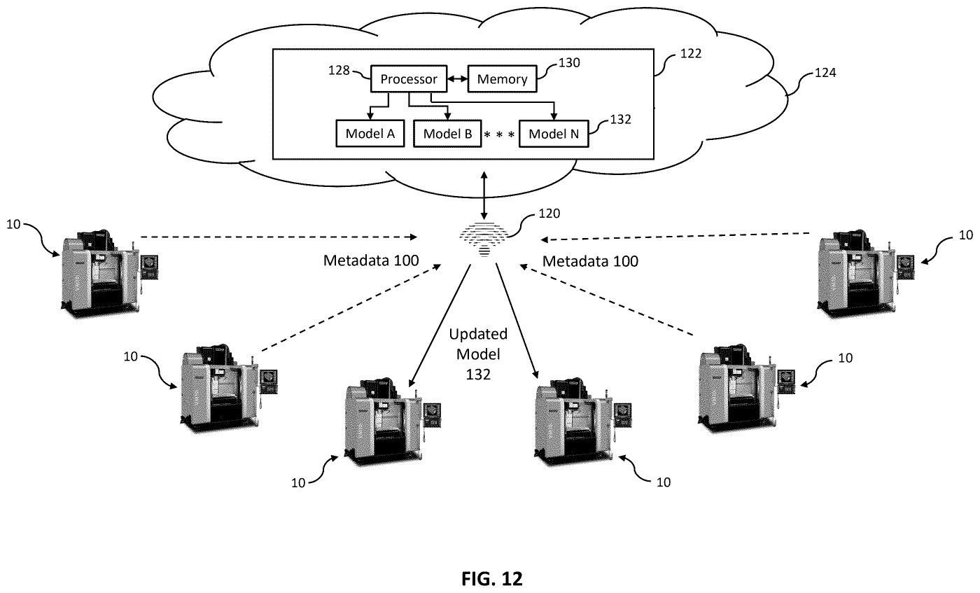

As shown in FIG. 12, the system according to the present disclosure leverages operator input during the normal daily use of a CNC machine 10 without requiring any self-reporting from operators and without the need to for any additional hardware or sensors. The metadata 100 associated with the normal daily use of the CNC machines 10 is communicated to the server 122 via the network 120 and used to improve the model 132. The updated model 132 is provided to other CNC machines 10 via the network 120 to improve their autonomous operation. With the Hurco 3D import feature for on-control tool path generation, operators are automatically generating (or “crowdsourcing”) labeled metadata 100 associated with the manufacturing process 50, which is automatically extracted and used for supervised machine learning to automate part programming setup, and operation of the CNC machine 10. By recording all the relevant metadata 100 with direct input through normal use of the CNC machine 10 that resulted in the manufacturing the final actual part, the system according to the present disclosure eliminates the challenges and inaccuracies associated with collecting data from disjoint systems or using self-reporting labelled data. No additional human effort is required to label data for machine learning, which when done manually is not only an extremely tedious and expensive process, but also introduces inaccuracies.

In another embodiment of the present disclosure, operator approval, rejection or correction of the results of the model 132 is not required. In this embodiment, after considerable data collection and model training, as well as incremental training with new updated metadata 100, the machine learning model 132 will be sufficiently accurate to no longer warrant human intervention to check or correct the outputs. In certain embodiments, to achieve this level of accuracy in the model 132, pre-classification of the part may be required. The objective of such pre-classification is to take advantage of similarities within industries to reduce the problem field that the machine learning model 132 needs to cover. The classifications may include, but are not limited to, medical, aerospace, automotive, turning, milling, turn-mill, 3-axis mill, 5-axis mill, etc.

Additionally, the identification of a specific customer or machine shop may be used to better model the processes and parts that are typical for that customer or machine shop. It is known that certain machine shops or part manufacturers have established standard techniques or guidelines for how they chose to machine parts and use standardized tooling and fixturing to improve operational efficiency. By identifying the end user of the model 132, the problem field for the model 132 may be significantly reduced.

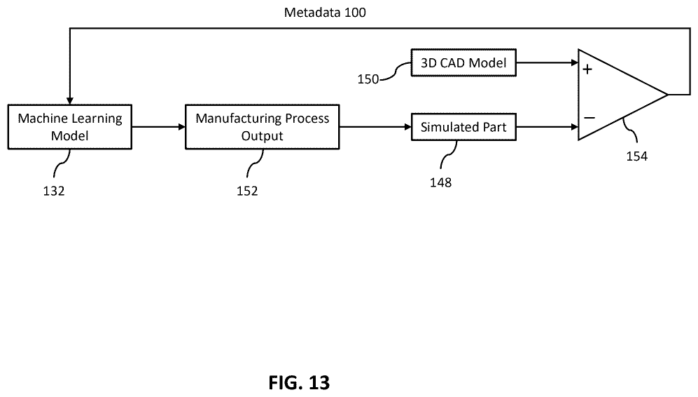

In another embodiment of the present disclosure, the model 132 is further automatically trained using simulations of the manufacturing processes output by the model 132. Referring to FIG. 13, after the machine model 132 is sufficiently trained, additional metadata 100 can be automatically generated through simulation and comparison of the simulated part 148 to the 3D CAD model 150 of the part. Such a self-correcting re-enforcement learning process involves the server 122 or the CNC control 12 performing repeated digital simulations of the part manufacturing programs 116 that are part of the machining process output 152 of the model 132 and computing the difference (represented by comparator 154) of each feature of the parts to the original 3D CAD models 150 of the parts to determine whether the machine learning model 132 accurately identified the features and chose the correct cutting tools and operations and sequences to produce the features. Any errors detected as differences between the simulations 148 and the original CAD model 150 are extracted as metadata 100 and used for additional incremental training of the machine model 132 to improve its accuracy.

In a further extension of this embodiment of the present disclosure, the automatic self-correcting re-enforcement learning also includes mechanistic modelling and simulation of cutting mechanics and vibrations which can be applied to analyze the cutting parameters and tooling selection the machine learning model 132 generated to validate the machine model 132. Any parameters and incorrect selections can be automatically identified based on allowable forces, tool deflection, surface roughness, and vibrations which can similarly be used as metadata 100 to further train and update the machine model 132 automatically.

In another application of the embodiments described herein, the metadata 100 collection process can be used, not only for automating the entire CNC manufacturing process, but also to predict the costs associated with producing parts for automated job estimation. As indicated above, job estimation generally requires very experienced staff that fully understand the entire process for manufacturing parts along with all costs and estimates of time required to the produce parts. Machine learning can be used to automate this process. This application requires additional cost data, measuring and recording timing for setup and manufacturing along with tooling, fixturing, and material costs. These data items are added as part of the metadata 100. Also, if the CNC machine 10 is fed by a robotic system such as a robotic loader or an automated bar feeder, the performance of these auxiliary devices can be monitored and recorded by the CNC control 12 and used to train the machine model 132.

As an additional feature of the systems and methods described herein, an anti-reverse engineering aspect may be added. In some instances, there is a need to safeguard the part data and ensure that it cannot be reverse engineered. To accomplish this, on the CNC control 12, the original part data is randomly morphed in a way such that the information needed for training the machine learning model 132 is not compromised but the original part data cannot be reverse engineered. Geometric and topological data, including feature dependencies and interactions, can be preserved for the purpose of training the machine learning model 132 but can be randomly morphed and re-assembled in a form such that the modified information cannot be reverse engineered to construct the original part. Since the objective in training the machine model 132 is to establish the weights and biases for the neurons in the network, training does not necessarily need to run on identical part data and can instead work with data that preserves what is important for learning yet is not identical to the original part. Randomized modifications of the part data may include scaling, position, orientation, and skew, subdivision into multiple parts or the assembly of multiple parts into a randomized single part, even randomized scaling of geometric aspects of the individual features, for example lines and arcs that define a pocket or contour, etc.

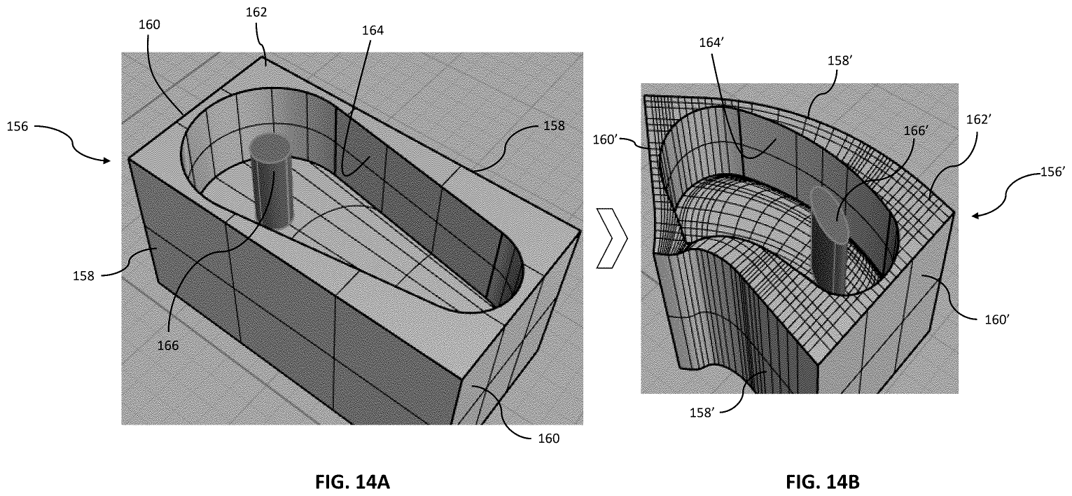

As an example of this feature, FIG. 14A shows a 3D model of a part 156 including two planar parallel sides 158 and two planar parallel ends 160, which are perpendicular to the sides 158. The part 156 also includes a top surface 162 into which a recess 164 is to be formed, leaving a cylindrical island 166 adjacent one end of the recess 164. FIG. 12B shows the same part 156′ after randomized modifications of the part data. As shown, the sides 158′ of the part 156′ are no longer planar and parallel. One of the ends 160′ is also no longer planar, and the ends 160′ are no longer parallel or perpendicular to the sides 158′. While the recess 164′ is still formed into the top surface 162′, it has a substantially different shape. The island 166′ of the morphed part 156′ is positioned adjacent the other end of the recess 164′ and is no longer cylindrical. While all of the features of the part 156 are still present in the morphed part 156′, such that the data associated with the morphed part 156′ may be used to train the model 132, the morphed part 156′ data cannot be used to reverse engineer the actual geometric and topological features of the original part 156.

While the description above generally describes the model 132 being resident on the server 122, and the metadata 100 being transmitted by the CNC control 12 to the server 122 for training the model 132, in other embodiments the CNC control 12 maintains the model 132 and uses the metadata 100 to train the model 132. Additionally, it should be understood that the server 122 need not be a traditional server which shares resources with and performs computations for the CNC control 12 as a client device. In certain embodiments, the server 122 is simply a remote computing device that is configured to communication with the CNC control 12. For example, the remote computing device may be an edge device in the end user's facility or a mobile device such as a laptop, smartphone, etc. It is contemplated by the present disclosure that as the computational power of various devices increases, the device that actually maintains and trains the various supervised machine learning models may be an implementation choice. In any event, the CNC control 12 will continue to automatically capture the metadata 100 during normal use. In some embodiments, the CNC control 12 will provide the metadata 100 to some other remote computing device for model training, such as described above, and in other embodiments the CNC control 12 will use the metadata 100 to train one or more models 132 maintained at the CNC control 12.

One of ordinary skill in the art will realize that the embodiments provided can be implemented in hardware, software, firmware, and/or a combination thereof. For example, the controllers disclosed herein may form a portion of a processing subsystem including one or more computing devices having memory, processing, and communication hardware. The controllers may be a single device or a distributed device, and the functions of the controllers may be performed by hardware and/or as computer instructions on a non-transient computer readable storage medium. For example, the computer instructions or programming code in the controller may be implemented in any viable programming language such as C, C++, C #, python, JAVA or any other viable high-level programming language, or a combination of a high-level programming language and a lower level programming language.

As used herein, the modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range “from about 2 to about 4” also discloses the range “from 2 to 4.”

It should be understood that the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

We claim:

1. A method for automating CNC manufacturing, comprising:
receiving, at one or more servers over a network, metadata from a plurality of CNC machines, the metadata from each CNC machine being automatically generated by a CNC control of the CNC machine as a result of an operator loading a CAD file of a first part to be formed by the CNC machine into CAM software of the CNC control and using the CAM software to define manufacturing process parameters and tool path parameters for forming the first part;
training, by the one or more servers, a supervised machine learning model using the metadata as labeled training data to produce a trained model; and
transmitting, by the one or more servers to at least one CNC machine of the plurality of CNC machines, model generated manufacturing process parameters and tool path parameters generated by the trained model for forming a second part.

2. The method of claim 1, wherein transmitting is in response to an operator loading a CAD file of the second part into CAM software of a CNC control of the at least one CNC machine.

3. The method of claim 1, wherein the model generated manufacturing process parameters include an identification of a CNC machine, a definition of stock material to form the second part, a setup of the CNC machine, and an identification of at least one feature of the second part.

4. The method of claim 1, wherein the model generated tool path parameters include a definition of at least one tool path to form the at least one feature, a definition of linking moves for a cutting tool of the CNC machine, a specification of a type and size of the cutting tool, and a specification of cutting tool parameters.

5. The method of claim 4, wherein the cutting tool parameters include parameters defining at least one of step-over, peck depth, plunge type, feed rate or cutting speed of the cutting tool.

6. The method of claim 1, wherein receiving metadata includes receiving part manufacturing programs containing the metadata from the plurality of CNC machines.

7. The method of claim 6, wherein each of the part manufacturing programs is generated by a packaging module of a CNC control of one of CNC machines of the plurality of CNC machines.

8. The method of claim 1, wherein transmitting further comprises transmitting, by the one or more servers to the at least one CNC machine of the plurality of CNC machines, a model generated cost estimate of forming the second part.

9. The method of claim 1, wherein the first CAD file is a 3D solid model CAD file.

10. The method of claim 1, wherein the model generated manufacturing process parameters and tool path parameters are configured to permit an operator to accept, reject or modify one or more of the parameters.

11. The method of claim 10, further comprising receiving, at the one or more servers over the network, updated metadata representing at least one of an operator rejection or modification to the one or more parameters, and training further comprises training the supervised machine learning model using the updated metadata as labeled training data.

12. The method of claim 1, further comprising receiving at least one of a classification of the second part or an identification of an end user of the at least one of the plurality of CNC machines.

13. The method of claim 1, further comprising:
generating a simulated part, by the one or more servers, using the model generated manufacturing process parameters and tool path parameters;
comparing, by the one or more servers, at least one feature of the simulated part to a corresponding feature in a CAD file of a part corresponding to the simulated part;
computing, by the one or more servers, a difference between the at least one feature and the corresponding feature;
using, by the one or more servers, the difference to generate new training data; and
training, by the one or more servers, the supervised machine learning model using the new training data.

14. The method of claim 1, further comprising validating, by the one or more servers, at least one parameter of the model generated manufacturing process parameters and tool path parameters by simulating cutting mechanics and/or vibrations associated with the at least one parameter.

15. The method of claim 14, further comprising:
identifying, by the one or more servers, at least one error associated with the at least one parameter based upon at least one of allowable forces, tool deflection, surface roughness and vibrations; and
training, by the one or more servers, the supervised machine learning model using the at least one error as labeled training data.

16. The method of claim 1, wherein the metadata includes randomized modifications of geometric and topological data of the first part to prevent reverse-engineering of the first part.

17. A method for automating CNC manufacturing, comprising:
capturing, by a CNC control of a CNC machine, metadata generated by loading a first CAD file of a first part into CAM software of the CNC control and using the CAM software to define manufacturing process parameters and tool path parameters for forming the first part using the CNC machine;
packaging, by a packaging module of the CNC control, the metadata into a part manufacturing program;
transmitting, by the CNC control, the part manufacturing program over a network to one or more servers which use the metadata in the part manufacturing program as labeled training data to train a supervised machine learning model to produce a trained model;
receiving, by the CAM software of the CNC control, a second CAD file of a second part; and
in response to receiving the second CAD file, receiving, at the CNC control, model generated manufacturing process parameters and tool path parameters generated by the trained model for forming the second part.

18. The method of claim 17, wherein the model generated manufacturing process parameters include an identification of a CNC machine, a definition of stock material to form the second part, a setup of the CNC machine, and an identification of at least one feature of the second part.

19. The method of claim 17, wherein the model generated tool path parameters include a definition of at least one tool path to form the at least one feature, a definition of linking moves for a cutting tool of the CNC machine, a specification of a type and size of the cutting tool, and a specification of cutting tool parameters.

20. The method of claim 17, wherein the model generated manufacturing process parameters and tool path parameters are configured to permit an operator to accept, reject or modify one or more of the parameters.

21. The method of claim 20, further comprising transmitting, by the CNC control over the network, updated metadata representing at least one of an operator rejection or modification to the one or more parameters for use by the one or more servers to further train the supervised machine learning model.

22. The method of claim 17, further comprising:
generating a simulated part, by the CNC control, using the model generated manufacturing process parameters and tool path parameters;
comparing, by CNC control, at least one feature of the simulated part to a corresponding feature in a CAD file of a part corresponding to the simulated part;
computing, by CNC control, a difference between the at least one feature and the corresponding feature;
using, by the CNC control, the different to generate new training data; and
transmitting, by the CNC control to the one or more servers over the network, the new training data to train the supervised machine learning model.

23. The method of claim 17, wherein the metadata includes randomized modifications of geometric and topological data of the first part to prevent reverse-engineering of the first part.

24. A system for automating CNC manufacturing, comprising:
a plurality of CNC machines, each including a CNC control; and
one or more servers communicatively coupled to the plurality of CNC machines over a network, the one or more servers including a plurality of supervised machine learning models;
wherein each CNC control includes a packaging module configured to package metadata into a part manufacturing program generated by loading a first CAD file of a first part into CAM software of the CNC control and using the CAM software to define manufacturing process parameters and tool path parameters for forming the first part using the corresponding CNC machine;
wherein each CNC control is configured to transmit the part manufacturing program over the network to the one or more servers;
wherein the one or more servers is configured to use the metadata in the part manufacturing program as labeled training data to train at least one of the plurality of supervised machine learning models to produce a trained model; and
wherein the one or more servers is configured to respond to a second CAD file of a second part being loaded into the CAM software of one of the CNC controls by transmitting to the one CNC control model generated manufacturing process parameters and tool path parameters generated by the trained model for forming the second part.

25. The system of claim 24, wherein the model generated manufacturing process parameters include an identification of a CNC machine, a definition of stock material to form the second part, a setup of the CNC machine, and an identification of at least one feature of the second part.

26. The system of claim 24, wherein the model generated tool path parameters include a definition of at least one tool path to form the at least one feature, a definition of linking moves for a cutting tool of the CNC machine, a specification of a type and size of the cutting tool, and a specification of cutting tool parameters.

27. The system of claim 24, wherein the model generated manufacturing process parameters and tool path parameters are configured to permit an operator to accept, reject or modify one or more of the parameters.

28. The system of claim 27, wherein the one or more servers is further configured to receive over the network, updated metadata representing at least one of an operator rejection or modification to the one or more parameters, and train the at least one of the plurality of supervised machine learning models using the updated data.

29. The system of claim 24, wherein each of the CNC controls or one of the one or more servers is further configured to:
generate a simulated part using the model generated manufacturing process parameters and tool path parameters;
compare at least one feature of the simulated part to a corresponding feature in a CAD file of a part corresponding to the simulated part;
compute a difference between the at least one feature and the corresponding feature;
use the difference to generate new training data; and
train the at least one of the plurality of supervised machine learning models using the new training data.

30. The system of claim 24, wherein the one or more servers is further configured to validate at least one parameter of the model generated manufacturing process parameters and tool path parameters by simulating cutting mechanics and/or vibrations associated with the at least one parameter.

31. The system of claim 30, wherein the one or more servers is further configured to:
identify at least one error associated with the at least one parameter based upon at least one of allowable forces, tool deflection, surface roughness and vibrations; and
train the at least one of a plurality of supervised machine learning models using the at least one error as labeled training data.

32. A system for automating CNC manufacturing, comprising:
a CNC machine including a CNC control; and
one or more remote computing devices communicatively coupled to the CNC control over a network, the CNC control and/or the one or more remote computing devices including a plurality of supervised machine learning models;
wherein the CNC control is configured to extract metadata generated by loading a first CAD file of a first part into CAM software of the CNC control and using the CAM software to define manufacturing process parameters and tool path parameters for forming the first part using the CNC machine, the metadata being packaged as a part manufacturing program;
wherein the CNC control is configured to transmit the part manufacturing program over the network to the one or more remote computing devices;
wherein the CNC control and/or the one or more remote computing devices is configured to use the metadata in the part manufacturing program as labeled training data to train at least one of the plurality of supervised machine learning models to produce a trained model; and
wherein the CNC control and/or the one or more remote computing devices is configured to respond to a second CAD file of a second part being loaded into the CAM software of the CNC control by accessing model generated manufacturing process parameters and tool path parameters generated by the trained model for forming the second part.
